(19) United States
(12) Patent Application Publication
(10) Pub. No.: US 2024/0281728 A1
(43) Pub. Date: Aug. 22, 2024

(54) METHODS AND SYSTEMS FOR EVENT DETECTION AND ADJUSTMENT OF OPERATIONAL RESOURCES

(71) Applicant: AMADEUS S.A.S., Biot (FR)

(72) Inventors: Akshay BHAWAY, Bengaluru (IN); Swarup Kumar SAHOO, Balangir (IN); Lisong GOU, Antibes (FR); Mourad BOUDIA, Valbonne (FR); Alexis Paul RAVANEL, Antibes (FR); Nicolas HAUVILLER, Valbonne (FR)

(21) Appl. No.: 18/170,692

(22) Filed: Feb. 17, 2023

(51) Int. Cl. G06Q 10/0631

(52) U.S. Cl. CPC G06Q 10/0631

(57) ABSTRACT

A method in a computing device of adjustment of operational resources based on external events includes: retrieving input data from at least one data source external to the computing device; extracting, from the input data, an event detection record including a time period associated with an event, a location associated with the event, and an impact direction associated with the event; retrieving, based on the time period and the location, a set of operational resource data; generating, based on the event detection record and the set of operational resource data, an impact magnitude associated with the event; selecting, based on the impact direction and the impact magnitude, a supplier of the operational resources; and transmitting a notification to a computing device associated with the selected supplier, the notification including the event detection record.

### BACKGROUND

The deployment of resources such as vehicles (e.g., aircraft and the like) to provide services may be impacted by a wide variety of events external to the entity deploying such resources. The breadth and unpredictability of such events renders automated detection of the events and adaptation of resource deployment technically difficult, such that such detection and adaption is performed manually, and thus often inefficiently or not at all.

### SUMMARY

An aspect of the specification provides a method in a computing device of adjustment of operational resources based on external events, the method comprising: retrieving input data from at least one data source external to the computing device; extracting, from the input data, an event detection record including a time period associated with an event, a location associated with the event, and an impact direction associated with the event; retrieving, based on the time period and the location, a set of operational resource data; generating, based on the event detection record and the set of operational resource data, an impact magnitude associated with the event; selecting, based on the impact direction and the impact magnitude, a supplier of the operational resources; and transmitting a notification to a computing device associated with the selected supplier, the notification including the event detection record.

Another aspect of the specification provides a computing device, comprising: a communications interface; and a processor configured to: retrieve input data from at least one data source external to the computing device; extract, from the input data, an event detection record including a time period associated with an event, a location associated with the event, and an impact direction associated with the event; retrieve, based on the time period and the location, a set of operational resource data; generate, based on the event detection record and the set of operational resource data, an impact magnitude associated with the event; select, based on the impact direction and the impact magnitude, a supplier of the operational resources; and transmit a notification to a computing device associated with the selected supplier, the notification including the event detection record.

### BRIEF DESCRIPTIONS OF THE DRAWINGS

Embodiments are described with reference to the following figures, in which:

FIG. 1 is a diagram of a system for event detection and operational resource adjustment.

FIG. 2 is a diagram of certain internal components of the server in the system of FIG. 1.

FIG. 3 is a flowchart of a method for event detection and operational resource adjustment.

FIG. 4 is a diagram illustrating an example performance of blocks 305 and 310 of the method of FIG. 3.

FIG. 5 is a diagram illustrating an example performance of block 320 of the method of FIG. 3.

FIG. 6 is a diagram illustrating an example performance of block 335 of the method of FIG. 3.

### DETAILED DESCRIPTION

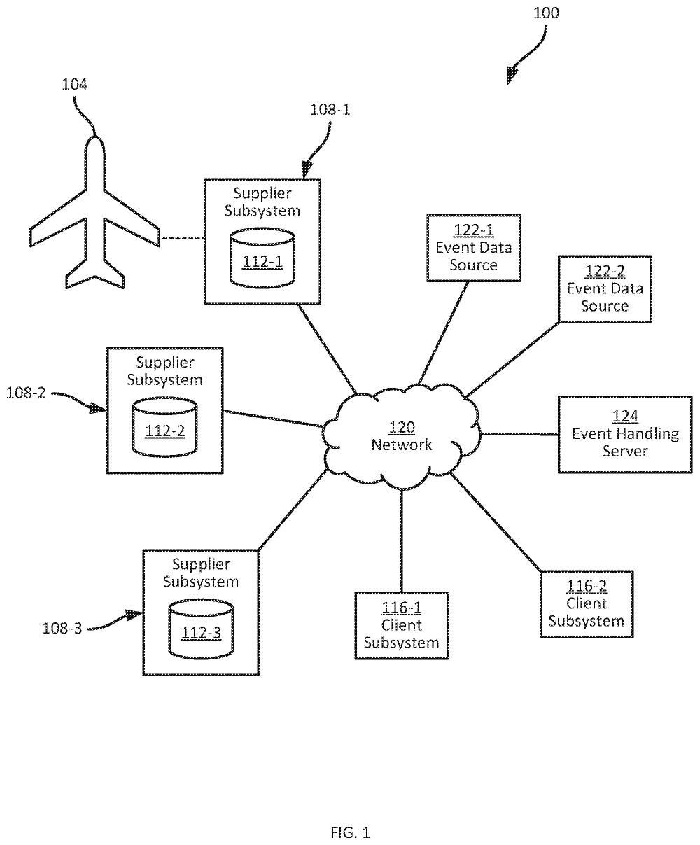

FIG. 1 depicts a system 100 for event detection and operational resource adjustment. The elements and functionality of the system 100 are discussed herein in the context of the provision of travel-related services. The operational resources in the discussion below therefore include physical assets such as an aircraft 104, and related resources such as staff, runway slots, and the like. In general, operational resources such as the aircraft 104 are deployed to transport cargo and/or passengers from origin locations to destination locations. Access to the aircraft 104 can be purchased, e.g., by or on behalf of the passengers, owners of the above-mentioned cargo, or the like, for defined dates and times, between defined locations, for defined prices. The dates and times of travel, locations, and prices can be defined by an operator of the aircraft 104 (e.g., an airline), also referred to herein as a supplier.

The system 100 includes a supplier subsystem 108-1 e.g., operated by or on behalf of the above-mentioned supplier. The supplier subsystem 108-1 includes various computing components enabling the deployment of operational resources such as the aircraft 104, as well as enabling the sale of tickets granting access to the aircraft 104. For example, the subsystem 108-1 can maintain a repository 112-1 containing operational resource data defining flight dates and times, prices, inventory (e.g., available seats on the aircraft 104). The repository 112-1 can also include purchase records defining any issued tickets for a given flight operated using the aircraft 104. A purchase record, i.e., a ticket, includes or is otherwise associated with identifying information for the holder of that ticket. The identifying information can be stored, for example, in a passenger name record (PNR) or the like, as will be apparent to those skilled in the art.

As will be apparent, the operational resource data mentioned above can also be maintained in various distinct repositories and managed via the actions of multiple computing modules implemented within the subsystem 108-1. The repository 112-1 is shown as a single element merely for simplicity of illustration.

The system 108 can include a plurality of distinct supplier subsystems, such as a supplier subsystem 108-2 maintaining a repository 112-2, and a supplier subsystem 108-3 maintaining a repository 112-3, as shown in FIG. 1. In the discussion below, supplier subsystems and their repositories may be referred to collectively as supplier subsystems 108 or repositories 112, and generically as a supplier subsystem 108 or a repository 112. Similar nomenclature is also used for other components herein. As will be apparent, the system 100 can include any number of supplier subsystems 108, and is not limited to the three subsystems 108 shown in FIG. 1.

The system 100 also includes client subsystems 116-1 and 116-2. As noted in connection with the supplier subsystems 108, the system 100 can include smaller or greater numbers of client subsystems 116 than shown in FIG. 1. Each client subsystem 116 can include a personal computing device such as a smart phone, tablet computer, desktop computer or the like, e.g., operated by an individual traveler (e.g., a purchaser or prospective purchaser of one or more of the above-mentioned tickets). In some examples, a client subsystem 116 can include a server and/or a plurality of computing devices, e.g., operated by a travel agency, aggregator entity, or the like.

In general, the client subsystems 116 can interact with the supplier subsystems 108, e.g., via a network 120 (which may be any suitable combination of local and wide-area networks), to view available flights in what may be referred to as shopping process, and optionally to purchase access to the aircraft 104 (or other aircrafts operated by the suppliers) for particular origin and destination locations, at particular dates and times.

The actual deployment of operational resources to provide previously purchased flight services, however, may be complicated by a wide variety of external events (i.e., events that are outside the control of any given supplier). Such external events can be disruptive, in that they interfere with the delivery of flights or other services. Examples of disruptive external events include extreme weather, volcanic eruptions, border restrictions implemented by regional and/or national governments, strikes or other labour-related disruptions, and the like. As will be apparent, those events may prevent aircraft from taking off or landing, prevent travelers from reaching airports and therefore cause travelers to miss flights, and the like.

Other external events may, rather than disrupting the delivery of planned flights or other deployments of operational resources, lead to increased demand for future flights or other services. Examples of such non-disruptive events include the removal or relaxation or border restrictions between jurisdictions, the announcement of a major sporting event in a particular location (which may spur demand for travel to that location), or the like.

Certain events, particularly the disruptive events noted above, may impose operational adjustments on suppliers (e.g., because aircraft at a given airport may be grounded by extreme weather). Other events, such as the non-disruptive examples mentioned above, may not impose operational adjustments, but operational adjustments such as modified ticket pricing, bundled services, or the like, may enable a supplier to increase the number of tickets sold, the price of such tickets, or the like. More broadly, it may be advantageous or even required for a supplier to adapt the deployment of operational resources to both types of event (disruptive/negative, and non-disruptive/positive).

Certain of the above-mentioned events are difficult or impossible to predict. That is, it may be difficult to anticipate an event prior to the actual occurrence of the event. Further, whether or not an event can be predicted prior to its occurrence, discovery of the event by a supplier subsystem 108 can be complicated by the breadth of possible events, and the wide variety of information sources from which such events may be discovered. As a result of the above difficulties, adjustments made in existing systems in response to such events (e.g., rescheduling or cancelling flights, creating promotional ticket sales, and the like) are performed manually by staff at the suppliers. Adjustments depend, in other words, on individual staff members discovering the existence of an event, and arbitrarily selecting an operational response (if any) to the event. Operational adjustments may therefore not occur until the impact of a given event is felt within the elements of the system 100 under a supplier's control, by which time the effectiveness of adjustments to mitigate the impact may be limited. In other cases, a supplier may not make any adjustments to an event, e.g., because the event was simply not discovered by the supplier.

Although the automation of event discovery and/or operational adjustment generation may be appealing to address the above challenges, various technical barriers complicate such automation. For example, external events may be detected from a wide variety of event data sources 122-1, 122-2, and so on, of greatly varying reliability. The sources 122 are external to the supplier subsystems 108, and may be operated by governmental authorities, news organizations, individuals, or other entities. The sources 122 may also publish or otherwise disseminate information corresponding to an event in widely varying formats, many of which are unstructured (e.g., using natural language, rather than defined name-value pairs that are readily consumable by software processes). For example, some event data sources 122 may publish event data in a predefined structured format to which entities such as the supplier subsystems 108 may subscribe, while event data sources 122 can include microblogging services operated by large numbers of individuals and used to publish natural language information, only a portion of which may define events.

In addition, the significant breadth of possible events and sources may lead to the collection of data defining large volumes of events with little or no operational impact on a given supplier subsystem 108. Due to the variable nature of the data defining events, however, assessing the potential impact of an event is also difficult. The volume of events that may result from an automated discovery system may be sufficiently large as to overwhelm staff of software processes tasked with devising operational adjustments in response to relevant events.

To resolve at least some of the above technical challenges, the system 100 further includes an event handling server 124 that performs various functions to discover events, assess the potential impact of such events (e.g., before that impact is felt by a supplier, in some examples, even for an event that has already occurred), and notify either or both of affected supplier subsystems 108 and client subsystems 116 of such events. In some examples, the server 124 can also generate data defining adjustments to operational resources, e.g., to mitigate the impact of disruptive events and/or take advantage of non-disruptive events to drive ticket sales or the like, e.g., more rapidly and consistently than in existing systems.

Although the examples described herein are in the context or air travel, it will be apparent to those skilled in the art from this discussion may also be applied to a variety of other systems and associated operational resources, including other travel-related services (e.g., ground-based travel such as trains or buses, hotels, and the like).

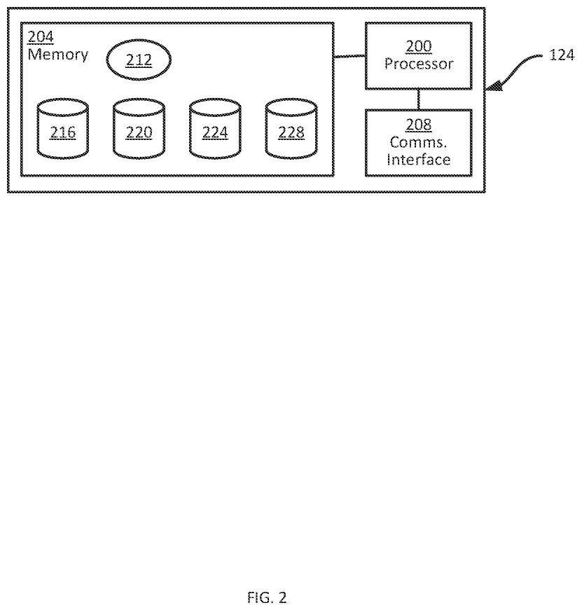

FIG. 2 illustrates certain components of the server 124. In the illustrated example, the server 124 includes at least one processor 200, such as a central processing unit (CPU), graphics processing unit (GPU), or the like. The processor 200 is interconnected with a memory 204, implemented as a suitable non-transitory computer-readable medium, such as a combination of volatile and non-volatile memory components (e.g., any one or more of Random Access Memory (RAM), read only memory (ROM), Electrically Erasable Programmable Read Only Memory (EEPROM), flash memory, magnetic computer storage, and the like). The processor 200 and the memory 204 are generally comprised of one or more integrated circuits (ICs).

The processor 200 is also interconnected with a communications interface 208, which enables the server 124 to communicate with the other computing devices of the system 100 via the network 120, including the supplier subsystems 108, client subsystems 116, and event data sources 122. The communications interface 208 therefore includes any necessary components (e.g., network interface controllers (NICs), and the like) to communicate via the network 120. The specific components of the communications interface 208 are selected based on upon the nature of the network 120. The server 124 can also include input and output devices connected to the processor 200, such as keyboards, mice, displays, and the like (not shown). Such input and output devices may be deployed remotely from the server 124, e.g., at a distinct computing device operated as an administrative terminal for the server 124 and connected to the server 124 via the network 120.

The components of the server 124 mentioned above can be deployed in a single enclosure, or in a distributed format. In some examples, therefore, the server 124 includes a plurality of processors, either sharing the memory 204 and communications interface 208, or each having distinct associated memories and communications interfaces.

The memory 204 stores a plurality of computer-readable programming instructions, executable by the processor 200. The instructions stored in the memory 204 include an event handling application 212, execution of which by the processor 200 configures the server 124 to retrieve raw input data from the event data sources 122, process the input data to detect events therein and generate structured representations of the detected events. Execution of the application 212 can also configure the processor 200 to generate notifications regarding detected events, for transmission to supplier subsystems 108 and/or client subsystems 116. In some examples, execution of the application 212 can also configure the processor 200 to automatically generate adjustments to operational data at one or more supplier subsystems 108 in response to event detections.

The memory 204 also stores various data processed during the execution of the application 212. In the illustrated example, the data stored in the memory 204 includes a source definition repository 216 containing configuration data corresponding to the event data sources 122. As discussed further below, the repository 216 includes, for each event data source 122, configuration data defining how the server 124 interacts with that source 122 to retrieve input data potentially defining an event. The configuration data may also include data defining processing stages for input data from the corresponding source.

The memory 204 also stores an input data repository 220, configured to store raw input data obtained from the event data sources 122, e.g., according to the configuration data in the repository 216. The memory 204 further stores an event detection record repository 224. As discussed below, the raw input data from the repository 220 is processed (e.g., according to configuration settings specified in the repository 216) to detect events therein and define the detected events in a predefined, structured format that is consumable by downstream processes implemented by the server 124.

The memory 204 can also store a repository 228 defining notification and/or recommendation rules, resources (e.g., graphics, text, and other data) and the like for each supplier subsystem 108. The data in the repository 228, in other words, can represent supplier profiles, e.g., defining which events a given supplier wishes to be notified of, and/or which adjustments the supplier wishes implemented or suggested in response to various events.

The repositories 216, 220, 224, and 228 can be implemented in various other arrangements in other examples. For example, the data contained in the repositories mentioned above can be stored in a smaller or larger set of repositories. Further, the functionality implemented by the application 212 can be implemented by a suite of distinct applications executed by the server 124 and/or associated computing devices, in other examples.

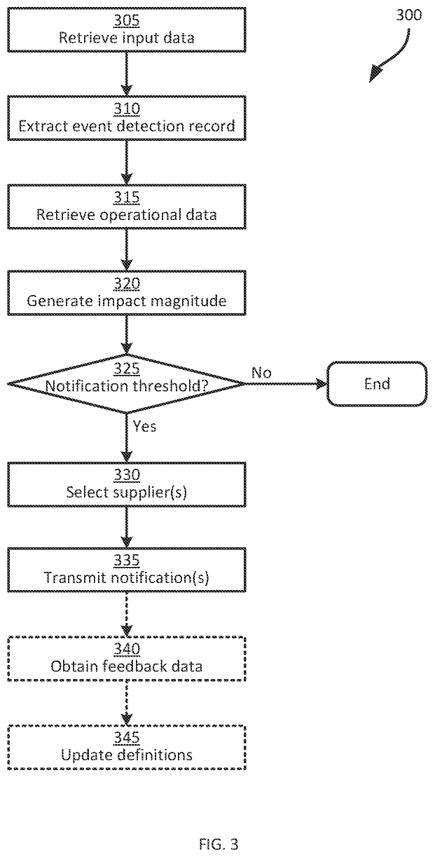

Turning to FIG. 3, a method 300 for event detection and operational resource adjustments is illustrated. The method 300 will be described below in conjunction with its performance in the system 100, in particular by the server 124 via execution of the application 212 by the processor 200.

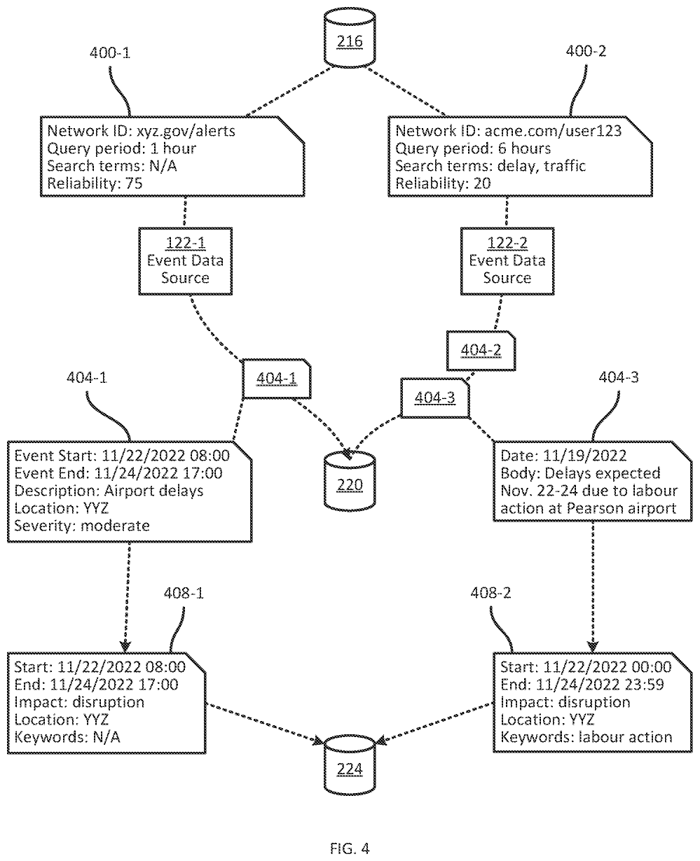

At block 305, the server 124 is configured to retrieve input data from at least one of the event data sources 122. Retrieval of input data is performed according to the source definitions in the repository 216. Turning to FIG. 4, example source definitions 400-1 and 400-2, corresponding to the event data sources 122-1 and 122-2 respectively, are illustrated. The source definitions contain, for each source 122, at least a network identifier for the source, such as a uniform resource locator (URL), internet protocol (IP) address, or the like. The server 124 is configured to use the network identifier in a given source definition to contact the corresponding source 122 to request input data.

The source definitions 400 can also include other configuration data controlling how and when the server 124 requests input data from the corresponding source 122. For example, the source definitions 400 include a query period (e.g., one hour for the source definition 400-1, and six hours for the source definition 400-2). The query period defines a frequency with which the server 124 queries each source 122 (e.g., every hour for the source 122-1, and every six hours for the source 122-2). A wide variety of other query periods can also be specified, and the definitions 400 can include further configuration data determining query timing, in some examples. For instance, a definition 400 can include specific times of day to query the corresponding source 122. In other examples, the server 124 can receive input data from one or more sources 122 without explicit queries, e.g., via a subscription mechanism by which the source 122 pushes notification(s) containing input data to the server 124. The server 124 can therefore implement block 305 without transmitting requests to the data sources 122, and can proceed to block 310, for example, upon receiving each event notification from a data source 122.

Certain source definitions 400 can also include configuration data defining search terms. For example, while the definition 400-1 does not include search terms (e.g., indicating that the server 124 retrieves any available input data from the source 122), the definition 400-2 includes the search keywords “delay” and “traffic”. As will be apparent, a wide variety of other search terms can also be employed. The search terms can be selected according to the nature of the corresponding source 122. For example, the source 122-1 may be a governmental agency tasked with publishing data defining disruptions to transit infrastructure in a given region. The source 122-2, in contrast, may be an individual microblogging account, and is therefore expected to include various content that is not relevant to event detection.

The definitions 400 can also include configuration data defining application programming interfaces (APIs) used to interact with the sources 122 (e.g., an API provided by the source 122 for retrieving input data, a website scraping process, or the like). The definitions 400 can further include authentication credentials, and/or input data schemas defining the expected format of input data from a given source. For example, the source 122-1 may produce input data describing events in a predefined structured format, with name-value pairs for event start date and time, end date and time, type, location, and the like. The source 122-2, on the other hand, may produce input data with structured metadata (such as the time and date a microblog post was generated), and an unstructured body (e.g., written in natural language).

Each definition 400 can also include a reliability score for the corresponding source 122. The reliability score, e.g., on a scale of zero to one hundred (although a wide variety of other scoring mechanisms can be employed), indicates how likely input data from the corresponding source 122 is to be accurate, and can be used by the server 124 in subsequent processing of the input data, as described below. In general, input data from a source 122 with a low reliability score is less likely to result in notifications and/or adjustments to operational resource data.

At block 305, therefore, the server 124 is configured to transmit requests to one or more of the event data sources 122 according to the definitions 400 corresponding to those sources 122. In response to such requests, the server 124 can receive input data from the sources 122, e.g., in the form of raw input records 404-1, 404-2, 404-3 as shown in FIG. 4. The number and nature of the input records 404 depends on the configuration data in the relevant definition 400, and on the source 122 itself. In some cases, a source 122 may return an indication that no new input data is available. The raw input records 404 can be stored in the repository 220, e.g., with an indication of the source 122 from which each record 404 was received.

As will be apparent, the use of source definitions 400 in the repository 216 enables the server 124 to retrieve input data from a readily scalable set of sources with widely varying characteristics. Subsequent processing of the input data by the server 124 then enables the server 124 to normalize the input data to a common, structured format for further action.

Example content for the input records 404-1 and 404-2 are shown in FIG. 4. For example, the input record 404-1 includes a set of name-value pairs, e.g., including a date of an event (which in the present example is three days in the future from a current date). The name-value pairs of the record 404-1 further include a description of the event, a location of the event (corresponding in this case to Toronto Pearson International Airport, IATA airport identification code “YYZ”), and a severity of the event (“moderate”). As will be apparent, although the record 404-1 is structured and thus readily consumable by computing devices executing software processes, the record 404-1 provides little detail as to the nature of the event, which may impede assessment of the event's impact.

The record 404-2 includes metadata such as a date on which the record 404-2 was generated at the source 122-2, and a body containing unstructured content (e.g., text, images, and the like presented in natural language rather than readily machine-consumable name-value pairs). The content defined in the record 404-2, therefore, may provide a more detailed description of an event than the record 404-1, but the unstructured nature of the record 404-2 complicates the automated processing of the record 404-2.

Referring again to FIG. 3, at block 310 the server 124 is configured to extract event detection records from the input data retrieved at block 305. The event detection records have a common data schema, in contrast to the input records 404, which can have a wide variety of formats and data schemas, as noted above. Further, the event detection records extracted at block 310 provide structured representations of events, e.g., including predefined sets of name-value pairs that are more readily consumable by other software processes than natural language.

To extract event detection records at block 310, each input record 404 is processed, for example according to mechanisms specified in the source definitions 400. For example, the source definition 400-1 can include a mapping between the structured schema of records from the source 122-1 (such as the input record 404-1) and a predefined event detection record schema. The source definition 400-2, in contrast, can include an identifier of one or more natural language processing (NLP) mechanisms to be executed using the content of input records 404 from the source 122-2 as input. NLP mechanisms can, as will be apparent to those skilled in the art, tokenize and process the content of the record to perform sentiment analysis, extract keywords, and the like. For example, one or more NLP models may be generated (e.g., via training data sets prior to performance of the method 300) to extract event keywords likely to indicate the type or category of an event, as well as to extract a time period associated with an event, and an impact direction associated with the event.

The impact direction provides a qualitative indication of the event's impact. Specifically, the impact direction indicates whether the event is likely to be a disruption (that is, a negative event) that may prevent the planned fulfillment of some flights or other travel services. A disruptive event may prevent services from being delivered as previously planned by directly impacting the operational resources involved in providing those services, as in the case of a volcanic eruption preventing take-off and landing of aircraft. In other examples, a disruptive event may prevent services from being delivered as planned by impacting the passengers of one or more flights, as in the case of a railway strike or the like preventing passengers from travelling to an airport. A non-disruptive (that is, a positive event) does not impede delivery of planned services, but instead may increase consumer demand for future services. For example, the announcement of an upcoming major sporting event in a given city may spur demand for travel to that city.

FIG. 4 illustrates example event detection records 408-1 and 408-2, extracted at block 310 from the input records 404-1 and 404-2, respectively. The records 408 both contain a common set of name-value pairs, populated based on the contents of the corresponding input records 404. In particular, each record 408 includes an event start date and time, an event end date and time (which together can define a duration, i.e., a time period over which the event is expected to extend) an impact direction, a location, and zero or more keywords. The event location, in the illustrated examples, corresponds to a specific airport, but the location value in event detection records can take various other forms, including geographic coordinates, one or more airport identifiers, one or more city identifiers, or the like. The event start and end dates and times may be indicated explicitly in the input data in some cases (e.g., for the input record 404-1), or inferred from the input data in other cases (e.g., for the input record 404-3, which includes only dates).

Each record 408 is stored in the repository 224 for further processing. In some cases, the performance of block 310 can lead to the discarding of an input record 404, e.g., if sentiment analysis or other extraction processing yields an indetermined impact direction (e.g., indicating a neutral event, with little or no expected impact, whether positive or negative). A record 404 may also be discarded if keywords extracted from the record 404 do not match any of a predefined set of keywords of interest.

Returning to FIG. 3, at block 315 the server 124 is configured to retrieve a set of operational resource data based on the time period (e.g., the time period between the event start date and time, and the event end date and time) and location defined in an event detection record 408. Event detection records 408 can be processed in sequence, e.g., substantially in real time as input data is received from the sources 122. The performance of block 315 can therefore be repeated for each record 408, and instances of block 315 may therefore occur in parallel or at overlapping time periods at the server 124.

The server 124 can retrieve operational resource data at block 315 by querying one or more of the supplier subsystems 108, and/or by querying locally stored data at the server 124. The operational resource data retrieved at block 315 defines, for example, suppliers that operate flights departing and/or arriving at the location(s) defined in the record 408. The operational resource data can also include historical data, e.g., identifying suppliers that have operated flights in the relevant location(s) within a configurable period of time prior to the current time. The operational resource data retrieved at block 315 can also, in some examples, identify the affected flights, and define a number of passengers booked in the affected flights.

At block 320, the server 124 is configured to generate an impact magnitude for an extracted event detection record 408, based on the retrieved operational resource data from block 315. While the impact direction mentioned above in connection with block 310 indicates whether an event is expected to have a disruptive or non-disruptive impact on the deployment of operational resources, the impact magnitude determined at block 320 indicates the expected severity of the impact. The server 124 can generate an impact magnitude in the form of a score, for example, based on any combination of the affected location(s) in the record 408, the time period in the record 408, and the affected suppliers and/or passengers in the data retrieved at block 315. For example, events affecting longer time periods can be scored higher, as can events affecting broader geographic regions and events affecting larger numbers of suppliers and/or passengers. The server 124 may store, for example, a decision tree or other ruleset for generating a score according to what event data is available (e.g., whether a number of affected passengers is available).

The server 124 can further be configured to apply one or more thresholds to the score, e.g., to produce a discretized impact magnitude selected from a relatively small set of possible values (e.g., low, medium, and high). The thresholds can be stored as configuration data at the server 124. For example, an event with time and/or location properties corresponding to more than ten thousand affected passengers may be assigned an impact magnitude of “high”, while an event with time and/or location properties corresponding to fewer than one thousand affected passengers may be assigned an impact magnitude of “low”. As will be apparent, a wide variety of other scoring mechanisms and thresholds may also be employed. The impact magnitude generated at block 320 can be stored in the corresponding event detection record 408.

As will be apparent, the diversity of event data sources 122 queried at block 305 can result in multiple event detection records 408 being generated that correspond to the same real-world event. In some examples, at block 320 the server 124 can therefore also aggregate event detection records, e.g., prior to determining the impact magnitude. The impact magnitude can then be determined for the aggregated event detection record, rather than the original event detection records 408.

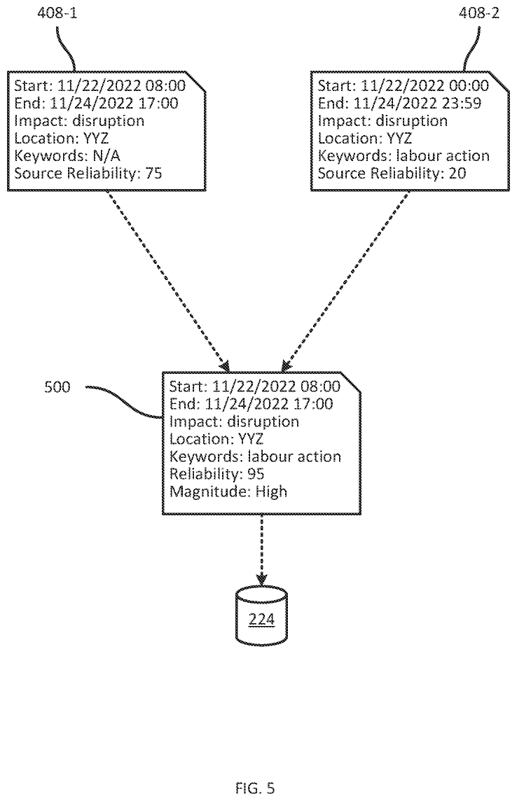

Turning to FIG. 5, the records 408-1 and 408-2 are illustrated, along with an aggregated event detection record 500. The server 128 can generate the record 500 by identifying records 408 with predefined sets of matching attributes, such as locations and time periods that are within certain thresholds of one another, and matching impact directions. In the illustrated example, the time periods/durations of the records 408 overlap substantially, and the locations of the records 408 match. The records 408 are therefore aggregated as corresponding to the same external event. The aggregated record 500 includes the time period and location, as well as the impact direction, from the records 408. As shown in FIG. 5, the start and end times from the record 408-1 have been retained, e.g., because of the higher reliability of the source 122-1. In other examples, however, intermediate start and/or end dates and times can be computed by the server 124.

The aggregated record 500 also includes the keywords from the record 408-2 (which are lacking from the record 408-1). In addition, the aggregated record can include an aggregated reliability, e.g., a sum of the reliability of the sources 122-1 and 122-2. That is, the fact that matching events have been reported by more than one event data source 122 increases the reliability of the reports, relative to the reliability of either source 122 in isolation. Various other mechanisms for generating an aggregated reliability value can also be employed. As seen from FIG. 5, the aggregation process yields an aggregated event detection record benefitting from the increased reliability of the source 122-1, and the more detailed content provided by the source 122-2.

Also shown in FIG. 5 is an impact magnitude stored in connection with the record 500. The record 500 can be stored in the repository 224, e.g., in addition to or instead of the records 408-1 and 408-2.

Referring again to FIG. 3, at block 325 the server 124 is configured to determine whether one or more attributes of an event detection record 408 (or, if applicable, aggregated record 500) exceed a notification threshold. The notification threshold can include, for example, a threshold impact magnitude. For example, the determination at block 325 can be affirmative for any event detection records with “high” impact magnitudes, and negative otherwise. In other examples, the notification threshold need not depend solely on the impact magnitude of an event detection record. For example, the server 124 can determine at block 325 whether the reliability score associated with the event detection record is above a threshold. The reliability score evaluated at block 325 is the reliability score of the corresponding source 122 for non-aggregated records 408, or a combined reliability score for aggregated records 500. That is, an event detection record with a high impact magnitude but a reliability score below a threshold may result in a negative determination at block 325.

The threshold(s) applied at block 325 can be specific to each supplier subsystem 108. For example, the repository 228 can contain notification thresholds for each supplier subsystem 108, such that the determination at block 325 for a given event detection record may be negative for one supplier subsystem 108, and affirmative for another supplier subsystem 108. The determination at block 325 may be repeated for each of a plurality of supplier subsystems 108, e.g., those affected by the relevant event (e.g., as determined at block 315).

When the determination at block 325 is negative, the event detection record can be ignored and/or discarded, and performance of the method 300 can end (for that particular event detection record). In other words, low-impact events, or events from low-reliability sources (that are not corroborated by additional sources) may be ignored, reducing the volume of notifications generated and transmitted by the server 124, as discussed below. When the determination at block 325 is affirmative, however, the server 124 proceeds to block 330.

At block 330, the server 124 is configured to select one or more supplier subsystems 108 according to the magnitude and direction of the event detection record, and optionally according to the profile data in the repository 228. The selection at block 330 is a selection of supplier subsystems 108 for the generation and transmission of notifications, to either or both of the supplier subsystems 108 themselves, or other computing devices associated with the supplier subsystems 108 (e.g., client subsystems 116 corresponding to ticket-holders for flights operated by a selected supplier subsystem 108). For example, the repository 228 can contain, for each supplier subsystem 108, types or categories of events (e.g., identified by keywords or the like) for which notifications are to be generated. Certain suppliers, in other words, can elect to receive notifications for only certain types of events, while ignoring other types of events.

At block 335, the server 124 is configured to transmit a notification to at least one computing device associated with the supplier(s) selected at block 330. The notification includes the event detection record, or data retrieved from the event detection record. The notification can also include, in some examples, an operational resource adjustment generated by the server 124 based on data in the repository 228. For example, the repository 228 can include rules for selecting operational adjustments according to various attributes of the event detection record. In some examples, a supplier subsystem 108 may configure profile data in the repository 228 to select operational adjustments including the suspension of new bookings and the rescheduling or cancellation of existing bookings during the time period of a high-impact disruptive event. A wide variety of other operational adjustments can also be stored in the repository 228, for a wide variety of other event attribute sets.

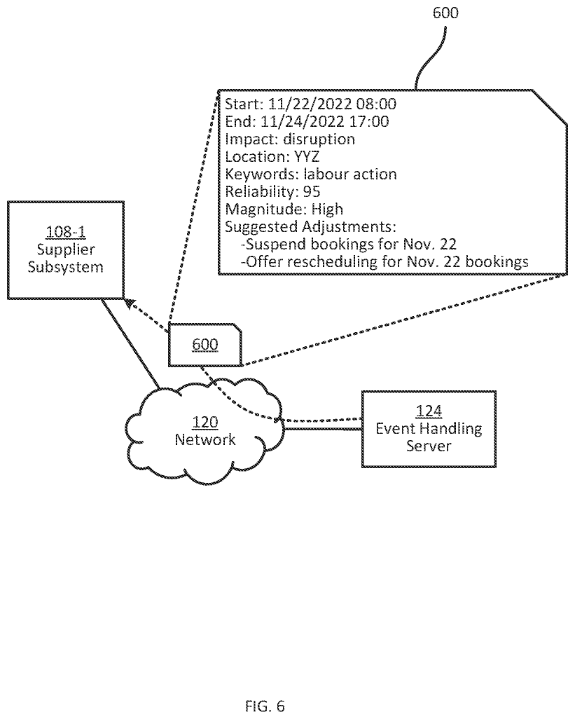

FIG. 6 illustrates an example performance of block 335, at which the server 124 transmits a notification 600 to the supplier subsystem 108-1, containing both the event data in the record 500 mentioned earlier, and suggested operational adjustments, e.g., retrieved from the repository 228. The notification 600 can include selectable options for accepting or rejecting the suggested adjustments. Further, the server 124 can be configured, if the suggested adjustments are accepted, to generate and send commands to the supplier subsystem 108-1 and/or other components of the system 100 to implement the suggested adjustments. Implementing the suggested adjustments can include, for example, generating further notifications to the client subsystems 116 (e.g., at least those client subsystems 116 with affected bookings).

In other examples, the server 124 can be configured to automatically apply the suggested adjustments, e.g., based on thresholds, event keywords or the like defined in the repository 228. In such examples, the notification 600 can include an indication that the adjustments have been applied.

Referring again to FIG. 3, at block 340, the server 124 can optionally be configured to obtain feedback data, e.g., from the supplier subsystem 108-1. At block 345, the server 124 can be configured to update one or more definitions in the repository 216, and/or in the data processing mechanisms used at blocks 310, 315, and 320. The feedback data can indicate an accuracy of at least one of the time period associated with the event, the location associated with the event, the impact direction, the selected supplier from block 330, or the impact magnitude determined at block 320. The feedback data can indicate, for example, that the impact magnitude from block 320 was inaccurate (e.g., overestimated the severity of the event). Such feedback data can be used to re-train or otherwise adjust the models used to extract event detection records at block 310 and/or generate impact magnitudes at block 320.

The feedback data can also indicate, for example, that data from the event detection record extracted at block 310 was inaccurate. For example, the feedback data can indicate that the location in the event detection record was inaccurate (i.e., did not match the actual location associated with the event). The server 124 can, in response to such feedback data, decrease the reliability score associated with the source(s) 122 that contributed to the event detection record. Conversely, feedback data indicating that an event detection was accurate can result in increased reliability scores for the originating sources 122.

In the description above, relational terms such as “first” and “second,” as well as reference numerals with suffixes such as “−1,” “−2” are used to distinguish one entity or action from another entity or action. Such terminology, absent an express indication to the contrary, does not necessarily indicate an actual order or other hierarchical relationship between the entities or actions. Terms such as “comprises,” “comprising,” “has”, “having,” “includes”, “including,” “contains”, “containing” and the like are intended to be open-ended, such that a process, apparatus or the like that comprises, has, includes, contains a list of elements does not necessarily include only those elements, but may also include other elements that are not expressly listed. The terms “a” and “an” are intended to indicate one or more, unless explicitly stated otherwise. Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

The scope of the claims should not be limited by the embodiments set forth in the above examples, but should be given the broadest interpretation consistent with the description as a whole.

1. A method in a computing device of adjustment of operational resources based on external events, the method comprising:
retrieving input data from at least one data source external to the computing device;
extracting, from the input data, an event detection record including a time period associated with an event, a location associated with the event, and an impact direction associated with the event;
retrieving, based on the time period and the location, a set of operational resource data;
generating, based on the event detection record and the set of operational resource data, an impact magnitude associated with the event;
selecting, based on the impact direction and the impact magnitude, a supplier of the operational resources; and
transmitting a notification to a computing device associated with the selected supplier, the notification including the event detection record.

2. The method of claim 1, further comprising:
storing a set of data source definitions each including a network identifier of a respective data source; and
retrieving the input data from the respective data sources based on the network identifiers.

3. The method of claim 2, wherein each source definition includes a reliability score associated with the corresponding data source; the method further comprising:
obtaining feedback data at the computing device, and updating the reliability score of at least one data source based on the feedback data.

4. The method of claim 3, wherein the feedback data indicates an accuracy of at least one of the time period associated with the event, the location associated with the event, the impact direction, the selected supplier, or the impact magnitude.

5. The method of claim 1, further comprising, prior to transmitting the notification:
determining whether the impact magnitude exceeds a notification threshold.

6. The method of claim 1, wherein each source definition includes a reliability score associated with the corresponding data source; the method further comprising, prior to transmitting the notification:
determining whether the reliability score exceeds a notification threshold.

7. The method of claim 1, wherein the operational resource data defines scheduled flights having origin and destination locations; and wherein selecting the supplier is further based on a proximity between the origin and destination locations, and the location associated with the event.

8. The method of claim 1, wherein the operational resource data comprises at least one of current operational resource data or historical operational resource data.

9. The method of claim 1, further comprising:
storing a set of operational resource adjustments in a memory of the computing device;
selecting, prior to transmitting the notification, an operational resource adjustment; and
transmitting the selected operational resource adjustment to the selected supplier, with the notification.

10. The method of claim 9, wherein transmitting the notification comprises automatically applying the selected operational resource adjustment.

11. A computing device, comprising:
a communications interface; and
a processor configured to:
retrieve input data from at least one data source external to the computing device;
extract, from the input data, an event detection record including a time period associated with an event, a location associated with the event, and an impact direction associated with the event;
retrieve, based on the time period and the location, a set of operational resource data;
generate, based on the event detection record and the set of operational resource data, an impact magnitude associated with the event;
select, based on the impact direction and the impact magnitude, a supplier of the operational resources; and
transmit a notification to a computing device associated with the selected supplier, the notification including the event detection record.

12. The computing device of claim 11, wherein the processor is further configured to:
store a set of data source definitions each including a network identifier of a respective data source; and
retrieve the input data from the respective data sources based on the network identifiers.

13. The computing device of claim 12, wherein each source definition includes a reliability score associated with the corresponding data source; and wherein the processor is further configured to:
obtain feedback data at the computing device, and update the reliability score of at least one data source based on the feedback data.

14. The computing device of claim 13, wherein the feedback data indicates an accuracy of at least one of the time period associated with the event, the location associated with the event, the impact direction, the selected supplier, or the impact magnitude.

15. The computing device of claim 11, wherein the processor is further configured, prior to transmitting the notification, to:
determine whether the impact magnitude exceeds a notification threshold.

16. The computing device of claim 11, wherein each source definition includes a reliability score associated with the corresponding data source; and wherein the processor is further configured, prior to transmitting the notification, to:
determine whether the reliability score exceeds a notification threshold.

17. The computing device of claim 11, wherein the operational resource data defines scheduled flights having origin and destination locations; and
wherein the processor is configured to select the supplier based on a proximity between the origin and destination locations, and the location associated with the event.

18. The computing device of claim 11, wherein the operational resource data comprises at least one of current operational resource data or historical operational resource data.

19. The computing device of claim 11, wherein the processor is further configured to:
store a set of operational resource adjustments in a memory of the computing device;
select, prior to transmitting the notification, an operational resource adjustment; and
transmit the selected operational resource adjustment to the selected supplier, with the notification.

20. The computing device of claim 19, wherein the processor is configured to transmit the notification by automatically applying the selected operational resource adjustment.
